(19) United States
(12) Patent Application Publication
(10) Pub. No.: US 2006/0178440 A1
(43) Pub. Date: Aug. 10, 2006

(54) Dispersions of a solid in an aqueous liquid including a polyalkyleneglycol ester or amide of a fatty acid dimer and/or trimer

(76) Inventor: Trevor Graham Blease, Cleveland (GB)

Correspondence Address: MAYER, BROWN, ROWE & MAW LLP, 1909 K STREET, N.W., WASHINGTON, DC, 20006, US

(21) Appl. No.: 10/518,233

(22) PCT Filed: Jun. 13, 2003
(86) PCT No.: PCT/GB03/02549

§ 371 Date: Jul. 29, 2005

(30) Foreign Application Priority Data
Jun. 17, 2002 (GB) 0213818.8

(51) Int. Cl. B01F 3/12; B01F 17/00; C09K 3/00

(52) U.S. Cl. 516/77; 516/198

(57) ABSTRACT

Polyethylene glycol esters and amides of polymerised fatty acids are useful dispersing agents for solids, particularly particulate solids e.g. agrochemicals, oil drilling mud components, pigments, personal care formulants, ceramics, magnetic materials, extenders, fillers, optical brighteners, textile auxiliaries, or soil removed from clothes during cleaning, in aqueous media. Particular such agents are of the formula (I): [Pol]-(COX)ₘ (I), where: Pol is the core residue of a polymerised fatty acid; m is 2 or 3; and each X is: OM; where M is H, a cationic salt forming species or a group —(AO)ₙR⁷; or a group —NR⁸—(AO)ₙR⁹; where AO is an alkylene oxide residue; n is from 1 to 100; and R⁷, R⁸ and R⁹ are as defined, from H, an anionic group, alkyl or alkenyl; provided that at least one X is a group of the formula —(AO)ₙR⁷ or —NR⁸—(AO)nR⁹.

This invention relates to dispersions of solids in liquids, particularly aqueous liquids, which include dispersing agents and in particular where the dispersing agents are derivatives of polymerised fatty acids.

Polymerised fatty acids are well known materials. They are usually made by polymerising fatty acids, particularly unsaturated fatty acids such as oleic acid, by heating with an acidic catalyst. The reactions that take place are complex including carbon skeleton rearrangements to give products including branched fatty acids as well as oligomers, particularly dimers and trimers of the fatty acids. The polymerised acids are often described as if they were mainly of the formula: 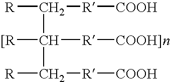
where each R is a typically C₃ to C₁₂, usually about C₅ to C₁₀, alkyl or alkenyl group; each R′ is a typically C₅ to C₁₅, usually about C₇ to C₁₀, alkylene or alkeneylene group; and n is 0 or 1. However, this formula should only be used as a rough guide as under the polymerisation conditions other reactions occur typically including rearrangement reactions which complicate the structures of the various groups and can give linking groups between the carboxylic acid chains rather than the simple bonds illustrated.

The present invention is based on the use of polyalkylene glycol esters of fatty acid dimers and/or trimers as dispersing agents for solids in, particularly aqueous, liquids.

Accordingly the present invention provides a dispersion of a solid in an aqueous liquid, which includes as a dispersing agent, a polyalkylene glycol ester or amide of a fatty acid dimer and/or trimer.

For convenience, the fatty acid dimers and trimers are referred to herein as polymerised fatty acids and the dispersing agents used in this invention as polymerised fatty acid dispersants or dispersing agents or, more particularly as polymerised fatty acid esters or amides.

Desirably compounds used as dispersing agents in the invention are of the formula (I):
[Pol]-(COX)ₘ (I)
where
Pol is the residue of a polymerised fatty acid after (nominal) removal of the carboxylic acid groups;
m is 2 (for a fatty acid dimer) or 3 (for a fatty acid trimer); and
each X is independently OM where M is: a hydrogen atom, a cationic salt forming species, particularly an alkali metal atom or an amine (including quaternary amine) or ammonium group; or
   a group —(AO)ₙR⁷; or
   a group —NR⁸—(AO)ₙR⁹:
      where:
AO is an alkylene oxide residue, particularly an ethylene oxide or propylene oxide residue, and may vary along the chain;
n is from 1 to 100; and
R⁷ is a hydrogen atom, a C₁ to C₂₂ alkyl group, a C₂ to C₂₂ alkenyl group, or an anionic group, which may include a charge balancing cation;
R⁸ is a hydrogen atom, a C₁ to C₁₀ alkyl group, or a group of the formula —(AO)ₙR⁹ where AO and n are independently as defined above and R⁹ is independently as defined below; and
R⁹ is a hydrogen atom, a C₁to C₂₂ alkyl group, or a C₂ to C₂₂ alkenyl group, or an anionic group, which may include a charge balancing cation;
   provided that at least one X is a group of the formula —(AO)ₙR⁷ or —NR⁸—(AO)ₙR⁹.

The corresponding polymerised fatty acid will, in the free acid form, be of the formula (II):
[Pol]—(COOH)ₘ (II)
where Pol, and m are as defined above.

As, desirably, all of the groups X are groups of the formula —(AO)ₙR⁷ or —NR⁸—(AO)ₙR⁹, particularly useful dispersing agents are of the formulae (Ia), (Ib) or (Ic):
[Pol]-(COO—(AO)ₙR⁷)ₘ (Ia); or
[Pol]-(COO—NR⁸—(AO)ₙR⁹)ₘ (Ib); or
[Pol]-(COO—N(—(AO)ₙR⁹)₂)ₘ (Ic)
where: Pol, AO, R⁷, R⁸, R⁹ n and m are as defined above.

The polymerised fatty acids that form the basis of the dispersants used in this invention are fatty acid dimers or trimers, or a mixture containing both dimer and trimer. Typically such polymerised fatty acids are manufactured industrially as mixtures of dimers and trimers commonly containing from 99 to 10% by weight dimer and correspondingly from 1 to 90% trimer. In commercially produced product, for a nominal dimer the proportions will usually be from 99 to 60%, particularly 98 to 70%, dimer and 1 to 40%, particularly 2 to 30%, trimer and for a nominal trimer from 70 to 85%, particularly 75 to 80%, trimer and 30 to 15%, particularly 25 to 20%, dimer. Other mixtures can be made up by mixing nominal dimer and trimer products.

In principle the fatty acids used to make the dimer can be any unsaturated fatty acid, but more usually will be at least mainly C₁₀ to C₂₂ fatty acids, and usually at least mainly C₁₈ fatty acids, commonly oleic acid or mixtures of oleic and linoleic acids.

The polymerised acid residue may be unsaturated or saturated. As normally manufactured both dimer acids and trimer acids generally include at least some unsaturation and if desired this may be hydrogenated to produce the corresponding saturated materials. Generally fully saturated materials are more stable, particularly thermally and oxidatively stable than unsaturated materials.

In the groups —(AO)ₙR⁷ and —NR⁸—(AO)ₙR⁹, the groups R⁷ and R⁹ can be non-ionic groups and are then typically hydrogen or alkyl or alkenyl groups. Usually they will be short chain alkyl groups e.g. C₁ to C₄ especially methyl or ethyl groups, which act as chain caps for the alkylene oxide chain. R⁸ is typically hydrogen or more usually a C₁ to C₄ alkyl, especially methyl or ethyl group. Where any R⁷ or R⁹ group is an anionic group it is typically a group OPO(OY)₂, OSO₃Y or CH₂CO₂Y, where each Y is independently hydrogen or a charge balancing cation desirably as defined for X.

Where X or Y are cationic salt forming species they are desirably a metal, such as an alkali or alkaline earth metal, for example sodium, potassium, calcium or magnesium, or ammonia or ammonium, or an organic amine, such as morpholine, piperidine, pyrrolidine, a mono-, di- or tri-lower alkylamine, for example ethyl-, diethyl-, triethyl- or dimethyl-propylamine, or a mono-, di- or tri-hydroxy-lower alkylamine, for example mono-, di- or tri-ethanolamine. Where such salts are used they are desirably of calcium, potassium and sodium, ammonia and amines, particularly triethylamine and triethanolamine.

However, desirably all of the groups X are groups of the formula —(AO)ₙR⁷ or —NR⁸—(AO)ₙR⁹.

The alkylene oxide group AO is particularly an ethylene oxide or propylene oxide residue. Generally it is desirable for aqueous dispersion that the polyalkylene oxide chain, —(AO)ₙ— is a homopolymeric polyethylene oxide chain. However, copolymeric chains including propylene oxide residues may be used if desired. When present the proportion of propylene oxide residues will typically be less than 50 mole %, usually less than 25 mole % and more usually less than 15 mole %. When mixtures of ethylene oxide and propylene oxide are present the co-polymeric chains can be random (stochastic) or block copolymer chains.

In esters compounds of the formula (I) used in the invention, the number, n, of alkylene oxide residues in the chain, within the broad range of 1 to 100, will usually be at least 5 and more usually at least 7.5. It is unlikely that chains much longer than about 50 will offer any substantial benefit in stabilising dispersions so desirably n is not more than 75 and will usually be not more than 50 and often not more than 30. Examples of the corresponding polyethylene glycol starting materials include alkoxy (particularly methoxy) PEGs 350 (n=ca 8), 550 (n=ca 12.5), 750 (n=ca 17) and 2000 (n=ca 45).

In amide compounds of the formula (I) used in the invention, n can be 1 as in alkanolamides, particularly dialkanolamides such as (di-)ethanolamides or (di-)propanolamides, or alkyl-alkanolamides, such as methyl- or ethyl-ethanolamides, or longer polyalkylene oxide chains can also be used e.g. where (each) n is from 3 to 30, more usually from 5 to 20.

Of course in (poly)alkylene oxide chains the number of alkylene oxide residues is an average value and may thus be non-integral.

As used it is generally convenient that the dispersant is neutral or near neutral e.g. having an aqueous pH of from 4 to 9. Generally extremes of pH either highly acid or highly alkali will be avoided to reduce the likelihood of destroying the dispersant by hydrolysis.

The polymerised fatty acid dispersants used in this invention can be made by methods generally known for making surfactant compounds. A particularly convenient reaction is by the direct reaction of the polymerised acid with a polyalkylene glycol or an amino-(poly)alkylene glycol, if desired in the presence of an esterification or amidation catalyst. Where the desired product is a non-anionic ester or amide, the polyalkylene glycol or amino-polyalkylene glycol respectively will usually be end capped. Polymerised fatty acid amide derivatives may also be made by amidation of the polymerised fatty acid with an alkanolamide, particularly a dialkanolamine or an alkylalkanolamine, followed by alkoxylation of the amide e.g. with ethylene oxide or propylene oxide or a mixture or combination of the two. In such a reaction sequence, it will usually be desirable to make a substantially fully amidated polymerised fatty acid e.g. desirably at least 90% and more usually at least 95% amidated, before alkoxylation to avoid or at least reduce the extent of making mixed products as are obtained by alkoxylating fatty acids (or esters).

Where the desired product is an anionically modified ester or amide, the reaction may be carried out with a polyalkylene glycol or amino-polyalkylene glycol to give a hydroxyl terminated ester or amide which is then reacted with an anionic reagent to form the desired product, although this does risk side reactions which may give rise to a mixed product. Another route to making an anionically modified ester or amide is to esterify/amidate the polymerised acid with an anionically modified polyalkylene glycol or amino-polyalkylene glycol.

After synthesis any remaining acidic groups e.g. COOH groups not reacted to form esters or amides or anionic groups in R⁷ or R⁹ may be neutralised with base or alkali either wholly or in part to form a suitable salt such as are mentioned above.

The dispersion can broadly be a personal care dispersion, an agricultural dispersion, a pigment dispersion or a dispersion of soil removed from clothes during cleaning and oil drilling mud dispersion. Generally the dispersions will be dispersions of particulate solids, usually finely divided particulate solids, in an aqueous medium, usually water, which may contain other components of a formulation. Accordingly, the present invention provides a dispersion of a solid in a liquid phase, particularly an aqueous liquid phase which includes as a dispersing agent at least one polymerised fatty acid ester or amide, particularly of the formula (I) above.

Examples of end use areas include dispersing pigments or dyes for paint or for inks, dirt and soil particles in cleaning media, particulate ceramic materials, magnetic materials for electronic recording materials; extenders and fillers; optical brighteners; textile auxiliaries; solids for drilling muds; personal care dispersions and agrochemical dispersions.

In personal care, the polymerised fatty acid dispersants can be used to disperse sunfilters and sunscreens or other cosmetics containing dispersed sunfilter and/or sunscreen components. Typically such sunfilters or sunscreens are or include dispersed physical sunscreens such as those based on titanium dioxide e.g. ultra-fine titanium dioxide, or zinc oxide e.g. ultra-fine zinc oxide, which are understood to act by strongly scattering ultraviolet radiation. The compositions, may also include chemical sunfilters or sunscreens such as compounds that absorb ultraviolet radiation, particularly UVB and UVA sunscreen agents. The amount of sunfilter and/or sunscreen material used will depend on the properties of the materials used, but typically for physical sunscreens the amount will be 0.1% to 5%, more usually from 0.25 to 2.5%, by weight of the overall formulation and for chemical sunfilters and/or sunscreens, when present, 0.05 to 3%, more usually from 0.1 to 1.5%, by weight of the overall formulation. Typically such formulations are made up as emulsions, commonly inverse (water-in-oil) emulsions and the physical sunfilter/sunscreen will generally be dispersed in the aqueous phase. The resulting product will thus usually be a combined suspension and emulsion, commonly referred to as suspoemulsions.

Suspoemulsions are a further important area in this aspect of the invention. They are mentioned above in connection with sunscreens, but other solid components can be included such as pigments as are often included in make up cosmetics. When pigments are used, they may be organic or inorganic and may be present in the oil phase, particularly for organic pigments and hydrophobic inorganic pigments, or in the present in the water phase, particularly for hydrophilic inorganic pigments, or in both phases, when used are typically present in concentrations of from 0.5 to 20% more usually from 1 to 10%, by weight of the emulsion.

Generally the amount of the polymerised fatty acid dispersants, particularly of the formula (I), used in cosmetic compositions of this aspect of the invention is from 0.5 to 7%, more usually from 1 to 5%, by weight of the formulation. The polymerised fatty acid dispersant(s) can be used alone or in combination with other, particularly polymeric, dispersants, but desirably, the proportion of polymerised fatty acid dispersant is at least 50%, more usually at least 75%, by weight of the total dispersant used in the cosmetic formulation.

In addition to the components mentioned above the emulsions of this aspect of the invention can include other components. Examples include:
preservatives such as those based on parabens (alkyl esters of 4-hydroxybenzoic acid), phenoxyethanol, substituted ureas and hydantoin derivatives e.g. those sold commercially under the trade names Germaben II, Nipaguard BPX and Nipaguard DMDMH, when used usually in a concentration of from 0.5 to 2% by weight of the emulsion;
perfumes, when used typically at a concentration of from 0.1 to 10% more usually up to about 5% and particularly up to about 2% by weight of the emulsion.

The polymerised fatty acid esters and amides are also useful as dispersants for solids for industrial uses. Examples of materials that can be dispersed in such applications include pigments and dyes for paint or for inks, especially flexographic, gravure and screen inks; dirt and soil particles in cleaning media; particulate ceramic materials; magnetic metal oxides or other magnetic materials for electronic recording materials; extenders and fillers e.g. for paints and plastics materials; optical brighteners; textile auxiliaries, particularly for dye baths; solids for drilling muds.

Pigments that can be used in such applications, particularly in paints an inks, include inorganic pigments such as titanium dioxide, zinc oxide, Prussian blue, cadmium sulphide, iron oxides (which may be magnetic or non-magnetic), vermillion, ultramarine and the chrome pigments, including chromates, molybdates and mixed chromates and sulphates of lead, zinc, barium, calcium, and mixtures and modifications of such pigments which are commercially available as greenish-yellow to red pigments under the names primrose, lemon, middle, orange, scarlet and red chromes; and organic pigments such as azo, disazo, condensed azo, thioindigo, indanthrone, isoindanthrone, anthanthrone, anthraquinone, isodibenzanthrone, triphendioxazine, quinacridone and phthalocyanine pigments, especially copper phthalocyanine and its nuclear halogenated derivatives, and also lakes of acid, basic and mordant dyes. Carbon black, although strictly inorganic, acts more like an organic pigment when dispersed. Preferred pigments, which are or behave as organic pigments, are phthalocyanines, especially copper phthalocyanines, monoazos, disazos, indanthrones, anthranthrones, quinacridones and carbon blacks.

Extenders and fillers that can be used include talc, kaolin, silica, barytes and chalk. and particulate ceramic materials include alumina, silica, zirconia, titania, silicon nitride, boron nitride, silicon carbide, boron carbide, mixed silicon-aluminium nitrides and metal titanates

Such dispersions typically contain from 5 to 95%, more usually from 10 to 60%, and especially from 20 to 50%, by weight of the solid, the precise quantity depending on the nature of the solid and the relative densities. The dispersion may be made by conventional method for making dispersions. Thus, the solid, the aqueous medium and the dispersant may be mixed in any suitable order and the mixture can then be subjected to mechanical treatment e.g. grinding or milling, to reduce the particles of the solid to an appropriate size and/or to suspend or disperse the solid particles in the medium.

The amount of dispersant used in this kind of application will typically be from 10 to 90%, more usually from 15 to 65% by weight of the pigment. The polymerised fatty acid dispersing agent can be used alone or in combination with other, typically polymeric dispersant, but desirably, the proportion of polymerised fatty acid dispersant, particularly of the formula (I) is at least 50%, more usually at least 75%, by weight of the total surfactant used in stabilising the dispersion.

The polymerised fatty acid dispersants, particularly of the formula (I) may also be used as soil release or soil anti-redeposition agents in laundry cleaning formulations. Generally, such laundry formulations are intended for use in aqueous laundry cleaning and may themselves be aqueous systems, solutions or dispersions. Soil release or soil anti-redeposition agents are used to remove soil from laundry by dispersing it in the aqueous laundry cleaning medium and/or to prevent or inhibit redeposition of suspended soil back onto the laundry later in the cleaning process.

The invention accordingly includes:
i a laundry cleaning formulation which includes detergent, builder and polyalkylene glycol ester or amide of a fatty acid dimer and/or trimer;
ii a method of cleaning clothes including immersing the clothes in an aqueous laundry medium including detergent, builder and polyalkylene glycol ester or amide of a fatty acid dimer and/or trimer under cleaning conditions whereby soil is removed from the clothes and suspended in the laundry medium; and
iii the use of a polyalkylene glycol ester or amide of a fatty acid dimer and/or trimer as a soil suspending or anti-redeposition agent in laundry cleaning.

The proportion of the polymerised fatty acid dispersant used in laundry formulations will typically be from about 0.05 to 25%, more usually from about 0.2 to about 10%, and desirably from 0.5 to 5%, by weight of the total laundry cleaning composition. Of course the concentration in the cleaning medium in use will be correspondingly less than this depending on the dosage of the cleaning composition.

The detergents used in such compositions can be those commonly used in laundry cleaning formulations and thus include anionic, nonionic, ampholytic and zwitterionic detergents and mixtures of more than one such type.

Examples of anionic detergents include alkali metal, C₈ to C₂₂, particularly C₁₀ to C₁₈, alkyl, particularly linear alkyl, benzene sulfonates; C₁₀ to C₃₀, particularly C₁₂ to C₁₈, alkyl ether sulphates, particularly as alkali metal or ammonium salts, and typically containing from 1 to 30, more usually 3 to 10 moles of oxyethylene residues; C₁₀ to C₂₄ olefin, particularly straight chain olefin, sulfonates.

Suitable non ionic surfactants include alkylene oxide, particularly ethylene and/or propylene oxide, derivatives, for example, an alkoxylated amine, alkyl phenol or alcohol. The alkyl group in the alkyl phenol it typically a C6 to C22, particularly C6 to C12, straight or branched chain group. The alcohol will usually be a primary or secondary alcohol with at straight or branched carbon chain and typically a C6 to C20, particularly a C10 to C16, alkanol. The non ionic surfactant will typically have a chain of, on average, from 1 to 10, particularly 3 to 8 alkylene oxide residues. The non-ionic surfactant may also be a C10 to C18, particularly a C12 to C16, amine oxide including 2 other groups which will usually be C₁ to C₃ alkyl or hydroxyalkyl groups. The composition may include two or more non ionic surfactants. The pour point may be adjusted by varying the liquid phase composition, for example, by including surfactants and/or polyethylene glycol of low pour point.

Suitable anionic or cationic surfactants include for example anionic detergents such as soaps, alkylbenzene or olefine sulphonates, alcohol sulphates or alcohol alkoxylate sulphates; and cationic surfactants such as di-C₁₀ to C22 and preferably di-C₁₆ to C₁₈ alkyl, di-lower alkyl ammonium salts or hydroxides for example chlorides or sulphates or for example fabric softeners of the C₁₀ to C₁₆ alkyl, di lower alkyl (for example methyl), substituted ethyl ammonium salts. Suitable zwitterionic detergents include betaines.

Typically the laundry composition will include from 10 to 50% and particularly 15 to 30% by weight of surfactant or detergent.

Optional further components of such laundry cleaning compositions include builders, typically used at proportions of from about 0 to about 70%, preferably 20 to 70% by weight of the total detergent composition. Builders promote the cleaning of the detergent by reducing the adverse effects of hard water; buffering the pH of laundry solutions between 7 and 12, more usually from 8 to 11; aiding fabric cleaning; and suspending particulate soils. Suitable builders include inorganic builders such as alkali metal or carbonates, bicarbonates, borates, silicates, sulphates and especially phosphorus containing builders such as phosphates and polyphosphates, such as orthophosphates and hexameta-phosphates, and especially tripolyphosphates; or organic builders such as hydroxycarboxylic acids e.g. citric and/or tartaric acid; amino polyacetates ethylenediamine tetraacetates, nitrilotriacetates and N-(2-hydroxyethyl)-nitrilodiacetates; phytic acid, usually as water soluble salts; polyphosphonates such as ethane-1-hydroxy-1,1-diphosphonic acid; and methylenediphosphonic acid, which may, and usually will, be in the form of alkali metal or ammonium salts. Mixtures of organic and/or inorganic builders can be used.

In addition to these ingredients, the detergent compositions can also contain from about 0.5 to about 40% of other optional ingredients which make the product more effective and more attractive. For example, bleaches such as peroxy bleaches can be included typically in an amount from about 5 to about 40%. Suitable inorganic bleaches include peroxy bleaches such as the alkali metal salts of perborates, percarbonates, persilicates, persulfates, and perphosphates; and suitable organic bleaches include peroxy acid salts such as of chloro- or nitro-perbenzoic, perazelaic, peroxy-phthalic acids, 4-chlorodiperoxyphthalic acids. The active bleach may be generated in situ by including a peroxy bleach agent and an activator separately in the composition. The bleach can be those mentioned above and the conventional activators such as acylated glycolurils, tetraacetyl methylene diamine, tetraacetyl ethylene diamine, triacetyl isocyanurate, benzoylimidazole, α,β-unsaturated acid anhydrides including phthalic or maleic anhydride, aldehydes, ketones, and their bisulfite adducts. For in situ preparation, the molar ratio of peroxygen bleach agent to bleach activator is desirably in from about 5:1 to 1:2, especially from 2:1 to 1:1.2.

Other components can include suds boosters such as diethanolamides, suds suppressing agents such as silicones and hydrophobic alkylene oxide condensates, tarnish inhibitors such as benzotriazole and ethylenethiourea, further soil suspending agents such as carboxymethyl cellulose, buffering agents, brighteners, fluorescers, perfumes, dyes and/or inert carriers, typically used in amounts of from 0.1 to 1.5% of the total composition.

The polymerised fatty acid dispersants can be used in various forms of dispersion in agrochemical applications. The invention accordingly includes an agrochemical dispersion, in which at least one polymerised fatty acid dispersant, particularly at least one compound of the formula (I), is included as a dispersant. Within this, more particularly the invention includes:
i an agrochemical dispersion in which a solid component particularly an active agrochemical, is dispersed in a liquid, particularly an aqueous, phase; or
ii an agrochemical suspoemulsion including an agrochemically active material which is dispersed in a first liquid, particularly an aqueous, component, a second liquid component being emulsified in the first liquid component.

The agrochemically active material(s) included in the emulsions and/or dispersions in this aspect of the invention can include one or more plant growth regulators, herbicides, and/or pesticides, for example insecticides, fungicides, acaricides, nematocides, miticides, rodenticides, bactericides, molluscicides and bird repellents. Examples of classes of actives include:
Herbicides: including water soluble, particularly non-selective, herbicides (used with water dispersible components in this invention), particularly N-phosphonomethyl glycine herbicides e.g. Glyphosate and Sulfosate, and the glufosinate and bipyridyl types of non-selective herbicides, triazines, substituted ureas, sulphonyl ureas, pyridine carboxylic acids, aryloxy alkanoic acids, 2-(4-aryloxy-phenoxy)propionic acids, bis-carbamates;
Fungicides: including thiocarbamates, particularly alkylenebis(dithiocarbamate)s, strobilurins, dicarboximides, benzimidazoles, azoles, inorganic fungicides;
Insecticides including benzoyl ureas and
Acaricides including tetrazines.

Particular applications of the polymerised fatty acid dispersant used in the invention in agrochemicals include:
Aqueous dispersions of solid components which can be insoluble actives, particularly fungicides or herbicides, but may be non-agrochemically active insoluble solid components. The proportion of polymerised fatty acid dispersing agent will typically be from 2 to 8%, more usually from 2 to 5%, by weight of the dispersion. Such dispersions may be incorporated into suspoemulsions (see below).
Suspoemulsions including at least one liquid and at least one solid disperse phase in an aqueous continuous phase are particularly suitable for agrochemical formulations which include an oil soluble active and a solid water insoluble (and usually also oil insoluble) active, with the oil soluble active present as an emulsion and the solid water insoluble active present as dispersed particles. The proportion of polymerised fatty acid dispersant is typically from 0.1 to 10%, more usually form 0.5 to 1.5% by weight of the emulsion. Suspoemulsions will commonly also include relatively hydrophilic surfactant e.g. one having an HLB value of 10 or more such as a hydrophilic alcohol alkoxylate, or an anionic surfactant, typically used at from I to 10%, more usually from 3 to 5%, by weight of the suspoemulsion, to aid emulsification of the oil disperse phase in the (usually) aqueous continuous phase.

In these agrochemical applications, the dispersions can include other particularly surfactants such as:
anionic surfactants e.g. alkali metal or alkali earth metal salts of sulphonated hydrocarbons such as alkyl benzene sulphonates particularly Ca dodecylbenzene sulphonate, typically included at from 0.1 to 10%, more usually from 2 to 3%, by weight of the emulsion; and/or
alcohol alkoxylates such as those based on C₈ to C₂₂, particularly C₁₂ to C₁₈, alcohols, which may have straight or branched, usually alkyl, chains, and which are alkoxylated with ethylene oxide, propylene oxide or copolymeric chains including residues of both ethylene oxide and propylene oxide, which may be block or random (statistical) copolymeric chains, commercially available examples include: Atlas G-5000, Atlox MBA 1306 and Synperonic A11/A20 available from Uniqema. Alcohol alkoxylates are typically included at from 0.1 to 10%, more usually from 2 to 3%, by weight of the emulsion.

In agrochemical compositions, the polymerised fatty acid dispersants can be used alone or in combination with other polymeric surfactants, but desirably, the proportion of polymerised fatty acid dispersant is at least 50%, more usually at least 75%, by weight of the total polymeric surfactant used as an emulsifier and/or stabiliser in the composition.

The following Examples illustrate the invention. All parts and percentages are by weight unless otherwise specified.

Materials

| | |
|---|---|
| Reagents | |
| Pripol 1040 | Oleic trimer acid ex Uniqema (a mixture of about |
| | 78% oleic acid trimer and about 22% dimer) |
| Pripol 1017 | Oleic dimer acid ex Uniqema (a mixture of about |
| | 80% oleic acid dimer and about 20% trimer) |
| methoxy-PEG 350 | monomethyl ether of polyethylene glycol (MW 350) |
| methoxy-PEG 550 | monomethyl ether of polyethylene glycol (MW 550) |
| methoxy-PEG 750 | monomethyl ether of polyethylene glycol (MW 750) |
| methoxy-PEG 2000 | monomethyl ether of polyethylene glycol |
| | (MW 2000) |
| Dispersants | |
| DSE1 | the product of SE1 |
| DSE2 | the product of SE2 |
| DSE3 | the product of SE3 |
| DSE4 | the product of SE4 |
| DSE5 | the product of SE5 |
| DSE6 | the product of SE6 |
| DSE7 | the product of SE7 |
| DSE8 | the product of SE8 |
| CD1 | Atlox 4913 - commercial comb copolymer |
| | dispersant ex Uniqema |
| CD2 | nonylphenol 10-ethoxylate |

Agrochemical active materials

| | |
|---|---|
| Ag1 | Carbaryl (97.5%) |
| Pigments | |
| Pig1 | Heliogen Green L8730 ex BASF |
| Pig2 | Printex 25, carbon black ex Degussa |
| Surf1 | Synperonic A7 (C_{13/15} alcohol 7 ethoxylate) ex Uniqema |
| Surf2 | Atlas G5000 - polyalkylene glycol surfactant |
| Surf3 | Synperonic 91/6 (C_{9/11} alcohol 6 ethoxylate) wetter ex |
| | Uniqema |
| 342 ppm | water having a standard hardness of 342 ppm |
| 1000 ppm | water having a standard hardness of 1000 ppm |

Test Methods
Viscosity—was measured on a Brookfield Viscosity RVT viscometer using the No 4 Spindle at 5 rpm (0.083 Hz). Results are given in centipoise (cP) (1 cP=1 mPa·s⁻¹)
Physical Suspension—was assessed after 1 and 4 hours as a 5% v/v dilution in 342 ppm and 1000 ppm hardness waters.

### SYNTHESIS EXAMPLES

### EXAMPLE SE1

Pripol 1040 (298 g; 0.333 mol) and methoxy PEG 350 (350 g; 1 mol) were charged a round bottomed flanged flask fitted with an anchor stirrer, thermocouple, distillation condenser and nitrogen sparge line. A slow nitrogen flow was established and the flask contents heated to 220° C. When the temperature reached about 190° C. titanium tetrabutoxide 0.5 g (1.43×10⁻³ mol) was added as catalyst, using a hypodermic syringe through a septum. Water of reaction was distilled from the reactor aided by the nitrogen sparge. The acid number of the flask contents was determined periodically while the temperature was maintained at about 220° C. for 12 hours. After 12 hours the heating was stopped and the flask contents were allowed to cool. A final sample had an acid number of 7.97 mg KOH.g⁻¹ indicating that the reaction was about 91% complete. The product was recovered as a dark brown, mobile liquid. IR spectrometry was used to confirm that the product was an ester.

### EXAMPLE SE2

Example SE1 was repeated but substituting Pripol 1017 for the Pripol 1040 used in Example 1 at a molar ratio of acid to methoxy PEG of 1:2.

### EXAMPLE SE3

Example SE2 was repeated but substituting methoxy PEG 550 for the methoxy PEG 350 used in Example 2 at a molar ratio of acid to methoxy PEG of 1:2.

### EXAMPLE SE4

Example SE1 was repeated but substituting substituting methoxy PEG 550 for the methoxy PEG 350 used in Example 1 at a molar ratio of acid to methoxy-PEG of 1:3.

### EXAMPLE SE5

Example SE1 was repeated but using a molar ratio of acid to methoxy PEG of 1:2.

### EXAMPLE SE6

Example SE5 was repeated but substituting methoxy PEG 550 for the methoxy PEG 350 used in Example 5 at a molar ratio of acid to methoxy PEG of 1:2.

### EXAMPLE SE7

Example SE1 was repeated but substituting substituting methoxy PEG 750 for the methoxy PEG 350 used in Example 1 at a molar ratio of acid to methoxy PEG of 1:3.

### EXAMPLE SE8

Example SE1 was repeated but substituting methoxy PEG 2000 for the methoxy PEG 350 used in Example 1 at a molar ratio of acid to methoxy PEG of 1:3.

### APPLICATION EXAMPLES

### EXAMPLE AE1

Various polymerised fatty acid dispersants were tested for their ability to disperse Ag1 (Carbaryl) in suspension concentrate formulations. Dispersions were also made up using CD1 (a high performance comb copolymer dispersing agent). The basic formulations used were:

| Material | Formulation 1 | Formulation 2 |
|---|---|---|
| Ag1 | 56.19 | 56.19 |
| Dispersant (nominal 100% material) | 0.20 | 0.40 |
| Surf1 | 1.20 | 1.00 |
| Surf2 | 0.60 | 0.60 |
| Xanthan Gum | 0.13 | 0.13 |
| Propylene Glycol | 6.00 | 6.00 |
| Water | 35.68 | 35.68 |

The results of viscosity measurements and suspension testing are set out in Table 1 below:

TABLE 1

| | | Formulation 1 | | | Formulation 2 | | |
|---|---|---|---|---|---|---|---|
| Ex | | Viscosity | Suspension (mm) | | Viscosity | Suspension (mm) | |
| No | Dispersant | (cP) | 342 ppm | 1000 ppm | (cP) | 342 ppm | 1000 ppm |
| AE1.1 | DSE1 | 6880 | 4 | 5 | 3100 | 2 | 3 |
| AE1.2 | DSE2 | 40000+ | 14 | 15 | 33500 | 11 | 12 |
| AE1.3 | DSE3 | 40000+ | 13 | 15 | 40000+ | 7 | 14 |
| AE1.4 | DSE4 | 39120 | 15 | 13 | 12960 | 8 | 7 |
| AE1.5 | DSE5 | 16720 | 4 | 6 | 11420 | 3 | 5 |
| AE1.6 | DSE6 | 19160 | 3 | 6 | 3400 | 2 | 3 |
| AE1.7 | DSE7 | 7440 | 4 | 7 | 4320 | 2 | 3 |
| AE1.8 | DSE8 | 28580 | 8 | 12 | 21200 | 7 | 9 |
| AE1C | CD1 | 8360 | 5 | 8 | 5360 | 2 | 4 |

These data indicate that the dimer/trimer dispersants and, in particular DSE1 and DSE7, are good dispersants for such agrochemicals and can match Atlox 4913 in dispersancy even in hard water.

### EXAMPLE AE2

Dispersants of the invention were tested in the dispersion of pigments Pig 1 (Heliogen Green L8730) and Pig2 (Printex 25) in aqueous systems. Initial testing to provide a preliminary evaluation of dispersion capability was carried out using the following formulation (based on 8% by weight of combined dispersant and wetter (Surf3) based on the amount of pigment used) and:

| Material | amount (g) |
|---|---|
| Pig2 (50%) | 20 |
| Surf3 | 0.4 |
| Dispersant | 1.2 |
| Water | 18.4 |

The formulations were milled in a Red Devil glass bead mill for 1 hour. The Brookfield Viscosity of the dispersions was measured at 25° C. (using Spindle No 29) after 1 Day storage at ambient temperature (1D) and after 5 freeze/thaw cycles between −4° C. and 50° C. (5C). The results are set out in Table 2 below.

TABLE 2

| | | | | Brookfield Visocsity (cP) | | | | |
|---|---|---|---|---|---|---|---|---|
| | Disp. | Description of | | spindle speed (RPM) | | | | |
| Ex No | Type | Dispersion | Aging | 100 | 50 | 10 | 5 | 0.5 |
| AEx. 1C | CD2 | v.mobile, foamy | 1D | 190 | 240 | 400 | 600 | — |
| | | | 5C | 300 | 400 | 800 | 1000 | 2000 |
| AEx. 1 | DSE5 | v. mobile, no foam | 1D | 230 | 300 | 500 | 600 | 2000 |
| | | | 5C | 300 | 400 | 800 | 1000 | 2000 |
| AEx. 2 | DSE7 | v. mobile, no foam | 1D | 130 | 160 | 200 | 200 | — |
| | | | 5C | 330 | 440 | 900 | 1000 | 2000 |
| AEx. 3 | DSE1 | v. mobile, no foam | 1D | 190 | 240 | 400 | 400 | — |
| | | | 5C | 670 | 940 | 2100 | 3000 | 10000 |
| AEx. 4 | DSE4 | v. mobile, no foam | 1D | 240 | 320 | 500 | 600 | — |
| | | | 5C | 360 | 480 | 1000 | 1200 | 4000 |
| AEx. 5 | DSE3 | v. mobile, no foam | 1D | 280 | 380 | 700 | 1000 | — |
| | | | 5C | 1360 | 2020 | 5100 | 8000 | 34000 |

1. A dispersion of a solid in an aqueous liquid, which includes as a dispersing agent, a polyalkylene glycol ester or amide of a fatty acid dimer and/or trimer.

2. A dispersion as claimed in claim 1 wherein the dispersing agent is of the formula (I):
[Pol]-(COX)ₘ (I)
where
Pol is the residue of a polymerised fatty acid with (nominal) removal of the carboxylic acid groups;
m is 2 (for a fatty acid dimer) or 3 (for a fatty acid trimer); and
each X is independently OM, where M is:
a hydrogen atom, a cationic salt forming species, particularly an alkali metal atom or an amine (including quaternary amine) or ammonium group; or
a group —(AO)ₙR⁷; or
a group —NR⁸—(AO)ₙR⁹:
where:
AO is an alkylene oxide residue, particularly an ethylene oxide or propylene oxide residue, and may vary along the chain;
n is from 1 to 100; and
R⁷ is a hydrogen atom, a C₁ to C₂₂ alkyl group, a C₂ to C₂₂ alkenyl group, or an anionic group, which may include a charge balancing cation;
R⁸ is a hydrogen atom, a C₁ to C₁₀ alkyl group, or a group of the formula —(AO)ₙR⁹ where AO and n are independently as defined above and R⁹ is independently as defined below; and
R⁹ is a hydrogen atom, a C₁ to C₂₂ alkyl group, or a C₂ to C₂₂ alkenyl group, or an anionic group, which may include a charge balancing cation;
provided that at least one X is a group of the formula —(AO)ₙR⁷ or —NR⁸—(AO)ₙR⁹.

3. A dispersion as claimed in claim 2 wherein the dispersing agent is a compound of one the formulae (Ia), (Ib) or (Ic):
[Pol]-(COO—(AO)ₙR⁷)ₘ (Ia); or
[Pol]-(COO—NR⁸—(AO)ₙR⁹)ₘ (Ib); or
[Pol]-(COO—N(—(AO)ₙR⁹)₂)ₘ (Ic)
where: Pol, AO, R⁷, R⁸, R⁹ n and m are as defined in claim 2.

4. A dispersion as claimed in claim 3 wherein AO is an ethylene oxide residue and R⁷ and R⁸ are each C₁ to C₄ alkyl groups.

5. A dispersion as claimed in claim 1 wherein the solid dispersed is at least one of: pigment; dye; dirt or soil particles; particulate ceramic material; magnetic material; extender or filler; optical brightener; textile auxiliary; drilling mud solids; personal care component; or agrochemical component.

6. A dispersion as claimed in claim 1 wherein the solid dispersed is or includes a physical sunscreen.

7. A dispersion as claimed in claim 6 wherein the physical sunscreen is a titanium dioxide or zinc oxide physical sunscreen.

8. A dispersion as claimed in claim 1 wherein the solid dispersed is or includes an inorganic or organic pigment or dyestuff and/or carbon black.

9. A dispersion as claimed in claim 8 wherein the inorganic pigment is at least one of titanium dioxide, zinc oxide, Prussian blue, cadmium sulphide, iron, vermillion, ultramarine, chrome pigments, including chromates, molybdates and mixed chromates and sulphates of lead, zinc, barium, calcium; and the organic pigment is at least one of azo, disazo, condensed azo, thioindigo, indanthrone, isoindanthrone, anthanthrone, anthraquinone, isodibenzanthrone, triphendioxazine, quinacridone and phthalocyanine pigments, lakes of acid, basic and mordant dyes.

10. A dispersion as claimed in claim 1 wherein the solid dispersed is or includes an extender or filler.

11. A dispersion as claimed in claim 10 wherein the extender or filler is at least one of talc, kaolin, silica, barytes or chalk.

12. A dispersion as claimed in claim 1 wherein the solid dispersed is or includes a particulate ceramic material.

13. A dispersion as claimed in claim 12 wherein the particulate ceramic material is at least one of alumina, silica, zirconia, titania, silicon nitride, boron nitride, silicon carbide, boron carbide, mixed silicon-aluminium nitrides or a metal titanate.

14. A dispersion as claimed in claim 1 wherein the solid dispersed is or includes dirt or soil particles and the formulation additionally includes at least one detergent.

15. A dispersion as claimed in claim 12 wherein the detergent is an anionic, nonionic, ampholytic or zwitterionic detergent or a mixture of more than one such type of detergent and the formulation additionally includes at least one builder and/or bleach and/or enzyme.

16. A dispersion as claimed in claim 1 wherein the solid dispersed is or includes an active agrochemical.

17. A dispersion as claimed in claim 1 in the form of an agrochemical suspoemulsion including an agrochemically active material which is dispersed in a first liquid, particularly an aqueous, component, a second liquid component being emulsified in the first liquid component.

18. A dispersion as claimed in claim 16 wherein the active agrochemical is one or more plant growth regulators, herbicides, and/or pesticides.
